(19) United States
(12) Patent Application Publication
(10) Pub. No.: US 2014/0196916 A1
(43) Pub. Date: Jul. 17, 2014

(54) FIRE-EXTINGUISHING BOMB

(71) Applicant: Chang Sung Ace Co., Ltd., Seongnam-si (KR)

(72) Inventors: Yeu Yong LEE, Seoul (KR); Jong Hee HAN, Seoul (KR)

(73) Assignee: Chang Sung Ace Co., Ltd., Seongnam-si (KR)

(21) Appl. No.: 14/076,756

(22) Filed: Nov. 11, 2013

(30) Foreign Application Priority Data
Jan. 11, 2013 (KR) 10-2013-0026238

(51) Int. Cl. A62C 19/00

(52) U.S. Cl. CPC A62C 19/00
USPC 169/28

(57) ABSTRACT

A fire-extinguishing bomb having: an outer casing; an extinguishant storage part installed in the outer casing, the extinguishant storage part having an open top covered with a mesh cover, and containing an extinguishant that is contained in a solid state and is burnt at a predetermined burning point or higher; a mesh inner casing placed in the outer casing such that the inner casing is spaced apart from the inner surface of the outer casing, with a coolant contained in the inner casing; a sealed inner casing holder connecting the inner casing to the inner surface of the outer casing; an ignition unit for igniting the extinguishant; and ejection holes formed through the upper part of the outer casing which is placed above the inner casing holder. The fire-extinguishing bomb can be effectively preserved for a lengthy period of time and can be easily moved.

### CROSS REFERENCE

This application claims foreign priority under Paris Convention and 35 U.S.C. §119 to Korean Patent Application No. 10-2013-0003247, filed Jan. 11,2011 with the Korean Intellectual Property Office.

### BACKGROUND OF THE INVENTION

1. Field of the Invention

The present invention relates, in general, to fire-extinguishing bombs and, more particularly, to a fire-extinguishing bomb that can be effectively preserved for a lengthy period of time and can be easily moved.

2. Description of the Related Art

The present invention relates to a fire-extinguishing bomb.

When a fire breaks out, a hand extinguisher containing extinguishing gas is generally used to extinguish a flame. To use the hand extinguisher, a user having the hand extinguisher approaches the base of a fire and directs the extinguishing gas of the extinguisher at the base of the fire.

Further, in the related art, a water based extinguisher is also used to extinguish a flame. However, the conventional water based extinguisher is problematic in that it cannot be effectively used to suppress an indoor fire, and cannot be used to suppress an oil fire.

Another problem of conventional extinguishers resides in that they may not be used to suppress a fire when a user cannot approach the base of a fire due to flames and poisonous gases generated from the flames.

In an effort to solve the above-mentioned problems, grenade style extinguishers have been developed and proposed.

However, conventional grenade style extinguishers are problematic in that they are required to be reduced in the weight, so they cannot contain a sufficient amount of extinguishant due to the reduction in the weight, and the ignition unit for igniting and detonating the extinguishant contained in a hurled grenade style extinguisher is designed to use a train of powder, so conventional grenade style extinguishers often malfunction due to a moisture contained therein.

Further, another problem of conventional grenade style extinguishers resides in that they are not effectively used with launching devices.

An example of the prior art technology related to the present invention refers to Korean Patent Application Publication No. 10-2012-0006599. However, the technology disclosed in the patent application publication did not propose a solution that can solve the above-mentioned problems.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a fire-extinguishing bomb that can be hurled and that includes: an outer casing having ejection holes for ejecting extinguishing gas in all directions; a sealed extinguishant storage, only the top of which is combined with a mesh cover and which contains an extinguishant therein; and an inner casing that receives the extinguishing gas generated from the burnt extinguishant and allows the extinguishing gas to move to the ejection holes after being cooled by a coolant, wherein the fire-extinguishing bomb can be effectively preserved for a lengthy period of time and can be easily moved.

Further, the present invention is also intended to propose a fire-extinguishing bomb that includes an ignition unit for electrically detonating the extinguishant, so the fire-extinguishing bomb can be less affected by moisture which infiltrates into the bomb or is generated in the bomb, so the fire-extinguishing bomb can maintain desired operational performance for a lengthy period of time and can minimize malfunction.

Further, the present invention is also intended to propose a fire-extinguishing bomb that is configured to be hurled by hand of a user or to be fired from a launching device.

In order to achieve the above object, according to one aspect of the present invention, there is provided a fire-extinguishing bomb, comprising: an outer casing defining therein an inner space isolated from the outside; an extinguishant storage part installed in the outer casing, the extinguishant storage part having an open top covered with a mesh cover, and having closed side and bottom walls, and containing an extinguishant that is contained in a solid state and is burnt at a predetermined burning point or higher; a mesh inner casing placed in the outer casing at a location above the extinguishant storage part such that the inner casing is spaced apart from an inner surface of the outer casing, with a coolant contained in the inner casing; a sealed inner casing holder connecting the inner casing to the inner surface of the outer casing such that the inner casing is fixed to the inner surface of the outer casing; and an ignition unit for igniting the extinguishant contained in the extinguishant storage part, wherein a plurality of ejection holes formed through an upper part of the outer casing which is placed above the inner casing holder, the ejection holes formed thoroughly from the inner surface to an outer surface of the outer casing.

Here, the outer casing may be formed as a tubular structure and an upper part of the outer casing above the inner casing holder may be formed as a dome shape.

Further, the outer casing may comprise: a head that is formed as a dome shape at an upper part of the outer casing above the inner casing holder; and a tubular body that is formed at a part of the outer casing below the inner casing holder, wherein the ejection holes may be formed in the head, wherein the ejection holes may be formed along a plurality of circumferences of the head which are spaced apart from each other at regular intervals based on a peak of the head.

Further, the ejection holes that are formed thoroughly from the inner surface to the outer surface of the head may be formed such that the ejection holes are directed gradually downward as locations of the ejection holes move downward from the peak of the head, so extinguishing gas generated from a burning of the extinguishant can be ejected to all directions through the perforated head.

The fire-extinguishing bomb may further include: a cover holder having a sealed structure, the cover holder connecting the cover to the inner surface of the outer casing, thereby fixing the cover to the inner surface of the outer casing.

Further, the coolant may be solid particles having a predetermined size or greater.

Further, the extinguishant may be formed of a solid aerosol material.

Further, the solid aerosol may comprise 45 to 80 wt % of potassium nitrate (KNO₃), 15 to 50 wt % of epoxy resin, 0.5 to 5 wt % of surfactant, and 0.5 to 5 wt % of catalyst.

Further, the ignition unit may comprise: a detonating part placed in the extinguishant contained in the extinguishant storage part; and a triggering part that heats the detonating part to a predetermined burning point or higher, wherein the extinguishant may be burnt by heat of the detonating part heated by the triggering part.

Further, the detonating part may comprise a hot wire or a resistance material that is heated to a predetermined burning point or higher by an electric current having a predetermined intensity or greater, the detonating part being placed in the central portion of the extinguishant contained in the extinguishant storage part, and the triggering part may supply an electric current having the predetermined intensity or greater to the hot wire or to the resistance material, thereby heating the hot wire or the resistance material so as to detonate and burn the extinguishant by heat of the hot wire or of the resistance material.

Further, the triggering part and the detonating part may be electrically connected to each other using a detonation wire.

The fire-extinguishing bomb may further include: a mode selecting unit that is used to select an operational mode of the ignition unit between an activated triggering mode in which the detonating part is electrically connected to the triggering part such that the triggering part can supply the electric current to the detonating part, and an inactivated triggering mode in which an electric connection between the triggering part and the detonating part is cut off; and a timer that controls the triggering part such that the triggering part supplies the electric current having the predetermined intensity or greater to the detonating part just after a preset period of time has passed in a state in which the mode selecting unit has selected the activated triggering mode.

The triggering part may further include: a battery that stores electric energy so as to supply the electric current having a predetermined intensity or greater.

As described above, the present invention can provide a fire-extinguishing bomb that can be effectively preserved for a lengthy period of time and can be easily moved.

Further, the present invention can provide a fire-extinguishing bomb that is less affected by the moisture which infiltrates into the bomb or is generated in the bomb, so the fire-extinguishing bomb can maintain desired operational performance for a lengthy period of time and can minimize malfunction.

Further, the present invention can provide a fire-extinguishing bomb that is hurled by hand of a user or is fired from a launching device.

### BRIEF DESCRIPTION OF THE DRAWINGS

FIG. 1 is a sectional view illustrating the construction of a fire-extinguishing bomb according to the present invention;

FIGS. 2 and 3 are a front view and a plane view illustrating the construction of ejection holes formed in the head of an outer casing according to the present invention;

FIG. 4 is a block diagram illustrating the construction of an ignition unit according to the present invention; and

FIG. 5 is a flowchart illustrating the operation process of the fire-extinguishing bomb according to the present invention.

### DETAILED DESCRIPTION OF THE INVENTION

The above and other objects, features and other advantages of the present invention will be more clearly understood from the following detailed description of preferred embodiments when taken in conjunction with the accompanying drawings.

However, it should be understood that the present invention is not limited to the embodiments that will be described hereinbelow, and various modifications, additions and substitutions are possible. The embodiments are provided to complete the description of the present invention and to allow those skilled in the art to appreciate the scope of the invention, so the scope of the present invention should be interpreted by the accompanying claims. Wherever possible, the same reference numerals will be used throughout the drawings and the description to refer to the same or like parts.

Hereinbelow, a fire-extinguishing bomb according to the present invention will be described in detail with reference to the accompanying drawings.

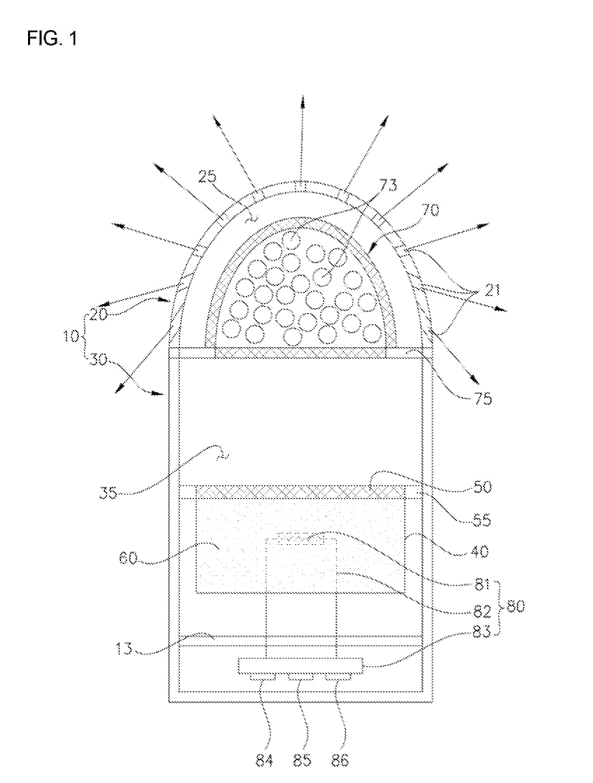

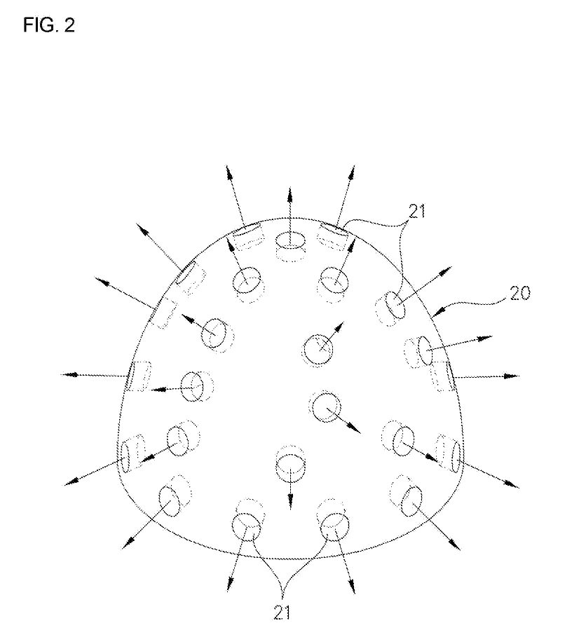

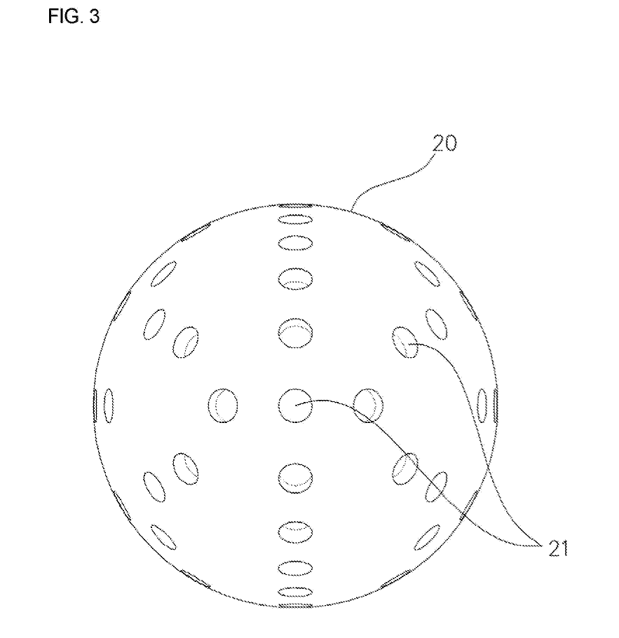

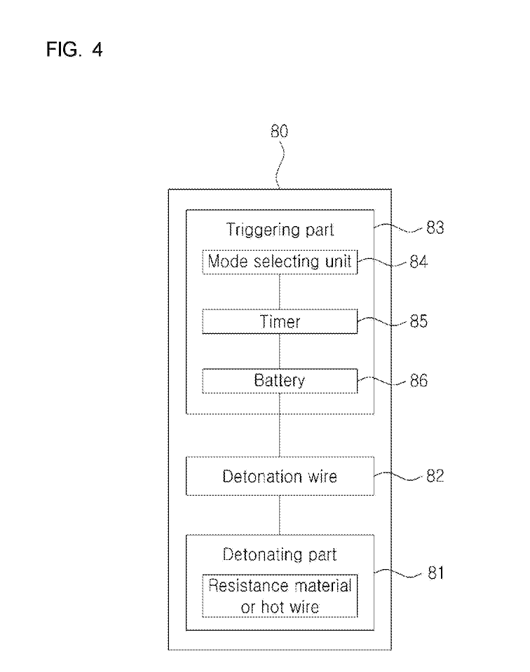

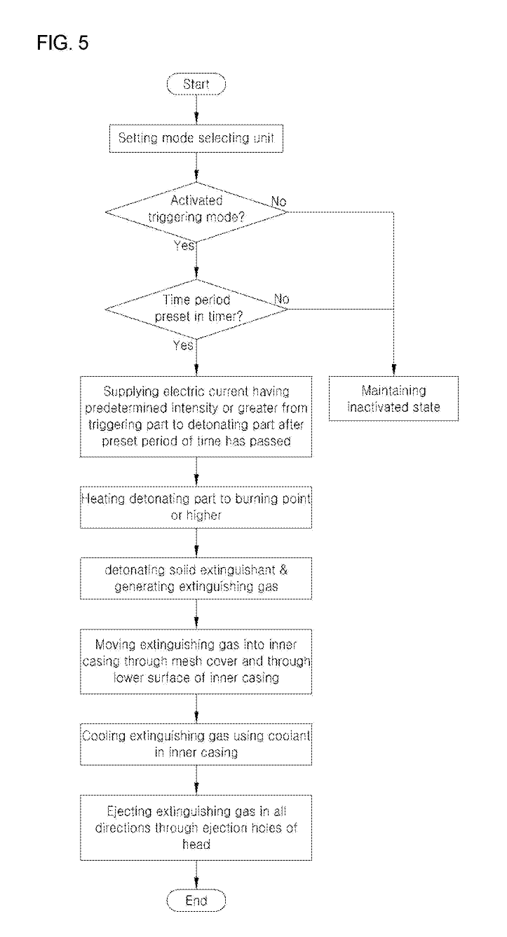

FIG. 1 is a sectional view illustrating the construction of a fire-extinguishing bomb according to the present invention. FIGS. 2 and 3 are a front view and a plane view illustrating the construction of ejection holes formed in the head of an outer casing according to the present invention. FIG. 4 is a block diagram illustrating the construction of an ignition unit according to the present invention. FIG. 5 is a flowchart illustrating the operation process of the fire-extinguishing bomb according to the present invention.

The fire-extinguishing bomb according to a preferred embodiment of the present invention includes an outer casing 10, an extinguishant storage part 40, an inner casing 70, an inner casing holder 75, and an ignition unit 80.

Described in detail, the fire-extinguishing bomb according to the present invention includes: an outer casing 10 that defines therein an inner space isolated from the outside; an extinguishant storage part 40 that is installed in the outer casing 10, has an open top covered with a mesh cover, has closed side and bottom walls, and contains an extinguishant 60 which is a solid material that is maintained in a solid state at a normal temperature and is burnt at a predetermined burning point or higher; an inner casing 70 that has a mesh structure and is placed above the extinguishant storage part 40 inside the outer casing 10 in such a way that the inner casing 70 is spaced apart from the inner surface of the outer casing 10, with a coolant 73 contained in the inner casing 70; an inner casing holder 75 that has a sealed structure and connects the inner casing 70 to the inner surface of the outer casing 10 such that the inner casing 70 can be fixed to the inner surface of the outer casing 10; and an ignition unit 80 that ignites the extinguishant 60 contained in the extinguishant storage part 40.

A plurality of ejection holes 21 are formed through an upper part of the outer casing 10 which is placed above the inner casing holder 75. Here, the ejection holes 21 are formed thoroughly from the inner surface to the outer surface of the outer casing 10.

The outer casing 10 has a sealed structure, with the inner space defined inside the outer casing 10 such that the outer casing 10 can be sealed from the outside.

Here, the outer casing 10 is formed as a tubular structure. Preferably, the outer casing 10 has a cylindrical shape, in which the top or the head 20 that will be described in detail later herein is formed as a dome shape or a hemispherical shape.

Further, both the extinguishant storage part 40 and the inner casing 70 are preferably installed in the inner space of the outer casing 10 at respective locations. The ignition unit 80 is preferably installed inside the outer casing 10, especially in a lower part of the inner space of the outer casing 10.

Here, it is preferred that the extinguishant storage part 40 be placed in the lower part of the inner space of the outer casing 10, and that the inner casing 70 be placed in the upper part of the inner space of the outer casing 10 at a location above the extinguishant storage part 40 in such a way that the inner casing 70 can be spaced apart from the extinguishant storage part 40.

The extinguishant storage part 40 is installed in the lower part of the inner space of the outer casing 10. Here, the extinguishant storage part 40 is open only in the top thereof, so the extinguishant 60 that is a solid material maintained in a solid state at a normal temperature and burnt at a predetermined burning point or higher can be contained in the extinguishant storage part 40.

Here, the ignition unit 80 is installed in a lower part of the inner space of the outer casing 10 at a location below the extinguishant storage part 40.

The extinguishant 60 preferably comprises a solid aerosol material.

Here, it is preferred that the solid aerosol comprise 45 to 80 wt % of potassium nitrate (KNO₃), 15 to 50 wt % of epoxy resin, 0.5 to 5 wt % of surfactant, and 0.5 to 5 wt % of catalyst.

The side and bottom walls of the extinguishant storage part 40 are closed walls. Here, the side walls of the extinguishant storage part 40 may comprise walls that are spaced apart from the inner surface of the outer casing 10 or may be formed by the inner surface of the outer casing 10.

The open top of the extinguishant storage part 40 is covered with a mesh cover 50 having a mesh structure.

Here, it is preferred that the mesh cover 50 be formed as a plate-shaped mesh structure.

The cover 50 has the mesh structure, so the solid extinguishant 60 contained in the extinguishant storage part 40 cannot pass through the mesh cover 50. However, when the solid extinguishant 60 is burnt and is converted to extinguishing gas, the extinguishing gas can pass through the mesh cover 50.

Here, the cover 50 is combined with the open top of the extinguishant storage part 40 by fixing the edge of the cover 50 to a cover holder 55 that is formed around the inner surface of the outer casing 10. Here, the cover holder 55 is formed as a sealed structure.

When the mesh cover 50 is combined with the open top of the extinguishant storage part 40, in which the side and bottom walls of the extinguishant storage part 40 are closed, the extinguishant 60 in the solid state can be stably stored in the extinguishant storage part 40. However, when the solid extinguishant 60 is burnt and is converted to extinguishing gas, the extinguishing gas can be discharged to the inner casing 70 after passing through the mesh cover 50.

Here, the whole body of the inner casing 70 is formed as a mesh structure that allows only particles having a predetermined size or less to pass through it.

The inner casing 70 is installed in the outer casing 10. Here, the inner casing 70 is arranged at a location above the extinguishant storage part 40 such that the inner casing 70 is spaced apart from the inner surface of the outer casing 10.

In other words, the inner casing 70 is arranged in the outer casing 10 in such a way that a first space 35 is defined between the inner casing 70 and the extinguishant storage part 40 and a second space 25 is defined between the inner casing 70 and the inner surface of the outer casing 10.

Here, it is preferred that the inner casing 70 be arranged such that the lower surface of the inner casing 70 faces the mesh cover 50 with the first space 35 defined between them, and the remaining surface of the inner casing 70 faces the inner surface of the outer casing 10 with the second space 25 defined between them.

Here, the inner casing 70 is fixed to the outer casing by the inner casing holder 75.

Here, to fix the lower surface of the inner casing 70 to the inner surface of the outer casing 10, the inner casing holder 75 connects the lower surface of the inner casing 70 to the inner surface of the outer casing 10.

The inner casing holder 75 has a sealed structure, so extinguishing gas generated from the burnt extinguishant 60 in the extinguishant storage part 40 flows to the inner casing 70 through only the lower surface of the inner casing 70, and then flows to the second space 25.

Here, the cover holder 55 also has a sealed structure, so the extinguishing gas generated from the burnt extinguishant 60 in the extinguishant storage part 40 flows to the second space 25 after sequentially passing through the first space 35 and the inner casing 70.

Here, the inner casing 70 contains a coolant 73 that cools the extinguishing gas that has been heated by burning heat.

The coolant 73 comprises particles having a predetermined size or greater that cannot pass through the mesh structure of the inner casing 70. The coolant 73 may be selected from various types of coolant that can absorb heat from high temperature gas when it comes into contact with the gas.

The coolant 73 may be selected from various solid coolant particles having a predetermined size or greater (for example, various metal particles or various metal compound particles, such as alumina, or various silicon compound particles, such as silica, or particles including various inorganic materials).

In other words, high temperature extinguishing gas that has been generated from the burnt extinguishant 60 in the extinguishant storage part 40 is cooled by the coolant 73 through a heat exchanging process in the inner casing 70, and then flows to the second space 25.

The plurality of ejection holes 21 are formed through the upper part of the outer casing 10 which is placed above the inner casing holder 75. Here, the ejection holes 21 are formed thoroughly from the inner surface to the outer surface of the outer casing 10.

In other words, when the extinguishant 60 is burnt in the extinguishant storage part 40, the extinguishing gas generated from the burnt extinguishant 60 is discharged to the first space 35 only through the mesh cover 50 that is combined with the open top of the extinguishant storage part 40 because the side and bottom walls of the extinguishant storage part 40 and the cover holder 55 are sealed. As the pressure inside the outer casing 10 increases, the extinguishing gas inside the first space 35 is introduced into the inner casing 70. In the inner casing 70, the extinguishing gas is cooled by the coolant 73 through a heat exchanging process, and then flows to the second space 25 prior to being discharged to the atmosphere through the ejection holes 21.

Here, it is preferred that the outer casing 10 be formed as a tubular structure and that the upper part of the outer casing 10 above the inner casing holder 75 be formed as a dome shape. More preferably, the outer casing 10 has a cylindrical shape.

The outer casing 10 comprises a head 20 that is formed as a dome shape or a hemispherical shape at the upper part of the outer casing 10 above the inner casing holder 75, and a tubular body 30 that is formed at a part of the outer casing 10 below the inner casing holder 75.

The ejection holes 21 are formed in the head 20. Here, it is preferred that the ejection holes 21 are formed along a plurality of circumferences of the head 20 which are spaced apart from each other at regular intervals based on the peak of the head 20.

Here, the ejection holes 21 that are formed thoroughly from the inner surface to the outer surface of the head 20 are specifically formed such that the ejection holes 21 are directed gradually downward and the downward inclination of the ejection holes 21 becomes gradually more rapid as the locations of the ejection holes 21 move downward from the peak of the head 20, so the extinguishing gas generated from the burning of the extinguishant 60 can be ejected to all directions through the perforated head 21.

Described in detail, the ejection hole 21 that is formed in the peak of the head 20 is axially formed such that the ejection hole 21 is in parallel to the axis of the outer casing 10, so the extinguishing gas that has been contained in the second space 25 can be ejected in an axial direction of the outer casing 10. Here, the inclination of the ejection holes 21 is determined such that, as the locations of the ejection holes 21 move gradually downward from the peak of the head 20, the ejection directions of the extinguishing gas from the ejection holes 21 are directed gradually downward.

For example, the ejection holes 21 that are formed in a lower part of the head 20 are configured such that the ejection holes 21 formed thoroughly from the inner surface to the outer surface of the head 20 are inclined so as to be directed to the body 30, so the extinguishing gas can be ejected from the head 20 to all directions through the ejection holes 21.

The ignition unit 80 is a unit that ignites the extinguishant 60 contained in the extinguishant storage part 40, thereby detonating and burning the extinguishant 60.

The ignition unit 80 may be selected from a variety of conventional ignition units that can burn the extinguishant 60 by a detonating action. Here, the ignition unit used in the fire-extinguishing bomb of the present invention may be configured to realize the following technical functions unlike conventional ignition units.

The ignition unit 80 used in the present invention comprises a detonating part 81 that is placed in the extinguishant 60 contained in the extinguishant storage part 40, and a triggering part 83 that heats the detonating part 81 to a predetermined burning point or higher.

That is, the detonating part 81 is heated by the triggering part 83, so the extinguishant 60 that has been maintained in the solid state at the normal temperature is detonated by the heat of the detonating part 81, and is burnt to be vaporized.

Here, the detonating part 81 comprises a hot wire or a resistance material that is heated to a predetermined burning point or higher by an electric current having a predetermined intensity or greater. The detonating part 81 is placed in the central portion of the extinguishant 60 contained in the extinguishant storage part. The triggering part 83 supplies an electric current having a predetermined intensity or greater to the hot wire or to the resistance material, thereby heating the hot wire or the resistance material so as to detonate and burn the extinguishant 60 by the heat of the hot wire or of the resistance material.

Here, the triggering part 83 is electrically connected to the detonating part 81 using a detonation wire 82.

The fire-extinguishing bomb according to the present invention may further include a mode selecting unit 84 and a timer 85.

The mode selecting unit 84 is used to select the operational mode of the ignition unit 80 between an activated triggering mode in which the detonating part 81 is electrically connected to the triggering part 83 such that the triggering part 83 can supply an electric current to the detonating part 81, and an inactivated triggering mode in which the electric connection between the triggering part 83 and the detonating part 81 is cut off.

Further, the timer 85 is a unit that controls the ignition unit 80 such that the triggering part 83 can supply an electric current having a predetermined intensity or greater to the detonating part 81 after a preset period of time has passed in a state in which the mode selecting unit 84 has selected the activated triggering mode.

Described in detail, when the mode selecting unit 84 has selected the inactivated triggering mode of the triggering part, the electric connection between the triggering part 83 and the detonating part 81 is cut off, so the triggering part 83 cannot supply an electric current to the detonating part 81, and the detonating part 81 cannot detonate or burn the extinguishant 60.

However, when the mode selecting unit 84 has selected the activated triggering mode of the triggering part, the detonating part 81 is electrically connected to the triggering part 83, so the triggering part 83 can supply an electric current to the detonating part 81.

Here, the timer 85 controls the ignition unit 80 such that the triggering part 83 can supply an electric current having the predetermined intensity or greater to the detonating part 81 after the preset period of time has passed in a state in which the mode selecting unit 84 has selected the activated triggering mode.

In other words, when the mode selecting unit 84 has selected the activated triggering mode, the timer 85 controls the ignition unit 80 such that the triggering part 83 can supply an electric current having the predetermined intensity or greater to the detonating part 81 after the preset period of time has passed, so the detonating part 81 is heated to the predetermined burning point or higher, thereby detonating and burning the extinguishant 60.

Here, the triggering part 83 further includes a battery 86.

The battery 86 is a means for storing an electric energy and supplies an electric current having the predetermined intensity or greater.

Here, the battery 86 is configured to be charged with electricity from an outside power source.

The fire-extinguishing bomb according to the present invention includes the detonating part 81 that is placed in the extinguishant 60, and the triggering part 83 that is electrically connected to the detonating part 81 and heats the detonating part 81 by supplying an electric current having a predetermined intensity or greater to the detonating part 81, so the fire-extinguishing bomb can be less affected by water or moisture which infiltrates into the bomb or is generated in the bomb, so the fire-extinguishing bomb can maintain the desired operational performance for a lengthy period of time and can minimize malfunction.

While the present invention has been described in connection with the exemplary embodiments of the present invention, it is apparent to a person having ordinary skill in the art that various modifications and changes can be made without departing from the scope of the present invention. Therefore, it is to be understood that the scope of the present invention is not limited to the foregoing embodiments but shall be defined by the accompanying claims and their equivalents.

What is claimed is:

1. A fire-extinguishing bomb, comprising:
an outer casing defining therein an inner space isolated from the outside;
an extinguishant storage part installed in the outer casing, the extinguishant storage part having an open top covered with a mesh cover, and having closed side and bottom walls, and containing an extinguishant that is contained in a solid state and is burnt at a predetermined burning point or higher;
a mesh inner casing placed in the outer casing at a location above the extinguishant storage part such that the inner casing is spaced apart from an inner surface of the outer casing, with a coolant contained in the inner casing;
a sealed inner casing holder connecting the inner casing to the inner surface of the outer casing such that the inner casing is fixed to the inner surface of the outer casing; and
an ignition unit for igniting the extinguishant contained in the extinguishant storage part, wherein a plurality of ejection holes formed through an upper part of the outer casing which is placed above the inner casing holder, the ejection holes formed thoroughly from the inner surface to an outer surface of the outer casing.

2. The fire-extinguishing bomb as set forth in claim 1, wherein the outer casing is formed as a tubular structure and an upper part of the outer casing above the inner casing holder is formed as a dome shape.

3. The fire-extinguishing bomb as set forth in claim 1, wherein the outer casing comprises:
a head that is formed as a dome shape at an upper part of the outer casing above the inner casing holder; and a tubular body that is formed at a part of the outer casing below the inner casing holder, wherein
the ejection holes are formed in the head, wherein
the ejection holes are formed along a plurality of circumferences of the head which are spaced apart from each other at regular intervals based on a peak of the head.

4. The fire-extinguishing bomb as set forth in claim 3, wherein the ejection holes that are formed thoroughly from the inner surface to the outer surface of the head are formed such that the ejection holes are directed gradually downward as locations of the ejection holes move downward from the peak of the head, so extinguishing gas generated from a burning of the extinguishant is ejected to all directions through the perforated head.

5. The fire-extinguishing bomb as set forth in claim 1, further comprising:
a cover holder having a sealed structure, the cover holder connecting the cover to the inner surface of the outer casing, thereby fixing the cover to the inner surface of the outer casing.

6. The fire-extinguishing bomb as set forth in claim 1, wherein the coolant comprises solid particles having a predetermined size or greater.

7. The fire-extinguishing bomb as set forth in claim 1, wherein the extinguishant comprises a solid aerosol material.

8. The fire-extinguishing bomb as set forth in claim 7, wherein the solid aerosol comprises 45 to 80 wt % of potassium nitrate (KNO₃), 15 to 50 wt % of epoxy resin, 0.5 to 5 wt % of surfactant, and 0.5 to 5 wt % of catalyst.

9. The fire-extinguishing bomb as set forth in claim 1, wherein the ignition unit comprises:
a detonating part placed in the extinguishant contained in the extinguishant storage part; and
a triggering part that heats the detonating part to a predetermined burning point or higher, wherein
the extinguishant is burnt by heat of the detonating part heated by the triggering part.

10. The fire-extinguishing bomb as set forth in claim 9, wherein
the detonating part comprises a hot wire or a resistance material that is heated to a predetermined burning point or higher by an electric current having a predetermined intensity or greater, the detonating part being placed in the central portion of the extinguishant contained in the extinguishant storage part, and
the triggering part supplies an electric current having the predetermined intensity or greater to the hot wire or to the resistance material, thereby heating the hot wire or the resistance material so as to detonate and burn the extinguishant by heat of the hot wire or of the resistance material.

11. The fire-extinguishing bomb as set forth in claim 10, wherein the triggering part and the detonating part are electrically connected to each other using a detonation wire.

12. The fire-extinguishing bomb as set forth in claim 10, further comprising:
a mode selecting unit that is used to select an operational mode of the ignition unit between an activated triggering mode in which the detonating part is electrically connected to the triggering part such that the triggering part can supply the electric current to the detonating part, and an inactivated triggering mode in which an electric connection between the triggering part and the detonating part is cut off; and
a timer that controls the triggering part such that the triggering part supplies the electric current having the predetermined intensity or greater to the detonating part just after a preset period of time has passed in a state in which the mode selecting unit has selected the activated triggering mode.

13. The fire-extinguishing bomb as set forth in claim 10, wherein the triggering part further comprises:
a battery that stores electric energy so as to supply the electric current having a predetermined intensity or greater.
